(19) United States
(12) Patent Application Publication
(10) Pub. No.: US 2005/0091693 A1
(43) Pub. Date: Apr. 28, 2005

(54) Dual mode set-top box that optimizes the delivery and user selection of audio or video programming over data networks

(75) Inventors: Gilbert A. Amine, Austin, TX (US); Joesph Robert Cowart, Austin, TX (US); John Wright, Austin, TX (US)

Correspondence Address: Matthew J. Booth & Associates, PLLC, P O BOX 50010, AUSTIN, TX, 78763-0010, US

(73) Assignee: ROCHELLE COMMUNICATIONS, INC., Austin, TX (US)

(21) Appl. No.: 10/904,584

(22) Filed: Nov. 17, 2004

Related U.S. Application Data
(63) Continuation of application No. 10/904,066, filed on Oct. 21, 2004.
(60) Provisional application No. 60/513,344, filed on Oct. 22, 2003.
(60) Provisional application No. 60/515,499, filed on Oct. 29, 2003.

(51) Int. Cl. H04N 7/173; H04N 7/18; H04N 7/16

(52) U.S. Cl. 725/100; 725/81; 725/131; 725/151

(57) ABSTRACT

This disclosure discloses a dual mode set-top box 10 that displays streamed video and/or plays streamed audio where both data streams are received from a media delivery network. The set-top box comprises a processor 100 that executes an operating system, communications functions, media streaming functions, and media decoding functions. The set-top box includes both a wired 1110 and a wireless 1108 connection to the media delivery network. The set-top box also includes an internal video display 118 and one or more external video outputs 120 that display streamed video received from the media delivery network. Further, the set-top box includes an internal audio device 131 and one or more external audio outputs 124 125 126 that play streamed audio received from the media delivery network.

### CROSS REFERENCE TO RELATED APPLICATIONS

This application claims the benefits of the earlier filed U.S. Provisional Application Ser. No. 60/513,344, filed 22 Oct. 2003 (10.22.2003), which is incorporated by reference for all purposes into this specification.

This application claims the benefits of the earlier filed U.S. Provisional Application Ser. No. 60/515,499, filed 29 Oct. 2003 (10.29.2003), which is incorporated by reference for all purposes into this specification.

This application is a continuation of the earlier filed U.S. patent application Ser. No. 10/904,066, filed 21 Oct. 2004 (10.22.2004), which is incorporated by reference for all purposes into this specification.

### FIELD OF THE INVENTION

This invention relates to optimizing the delivery and user selection of streamed audio and/or video media content over data networks. More specifically, this invention relates to dual-mode set-top boxes and a system and a method for optimizing the delivery and user selection of streaming multimedia programming.

### DESCRIPTION OF THE RELATED ART

The Internet has become a cultural fixture as a source of both information and entertainment. As time goes by, a convergence of older technologies for entertainment, media, and communications and the Internet is occurring. For example, voice over Internet protocol (VOIP) is the new conduit for routing telephone communication over the public Internet. Already, there are a number of radio stations that are re-broadcasting analog radio shows over the Internet. And, there are quite a few Internet-only “radio” stations or web sites that only broadcast audio entertainment or news on the Internet. Even cable TV networks now operate on the Internet. Because the cable company provides media and Internet access through the same physical connection, a digital set-top box from a cable TV company is essentially an Internet-enabled device connected to the Internet.

In the prior art, to access all of the various types of media, communications, and entertainment from the Internet, a user was required to have a number of different devices. For example, to view video content through the Internet, a user needed a digital set-top box connected to a television or a video monitor. Alternatively, a user needed a computer connected to the Internet. To receive audio content, a user needed a computer connected to the Internet. Or alternatively, a user could use an Internet-enabled audio device. Finally, to make and receive telephone VOIP calls, a user needed an Internet-enabled phone or a computer with the appropriate software. As can be seen from this brief review of multiple devices, there exists a need for a single device to allow media content connectivity for all of the above types of devices.

The present invention is a dual mode set-top box with telephony capability. The present invention is a “dual mode” device because it connects to the Internet or other type of media network through either a wired connection or a wireless connection and operates either fixed (tethered to an external display device such as a TV) or portably (utilizing only the internal display device). Additionally, the present invention can operate as a generic Internet protocol-based set-top box with the capability of providing access to subscription radio and television programming. Unlike prior art fixed set-top boxes which tie the user to the living room, the bedroom, or other fixed location, the present invention allows a user to take to take the media content with them to unwired parts of the house such as the backyard or even outside the home when mobile. When mobile, the present invention can operate with home-based Wi-Fi (802.11x) wireless networks, with commercial Wi-Fi networks, or with cellular data networks such as GSM/GPRS or CDMA/EV-DO.

The present invention features an on-board liquid crystal display with a Quarter VGA (QVGA) resolution of 320×240 pixels. The present invention is capable of connecting to a standard television or monitor and feeding it video at a resolution that can reach full D1 NTSC (720×480 pixels at 30 frames per second) or D1 PAL (720×576 pixels at 25 frames per second). One problem with the prior art is that most commercially-available video servers transmit data at the maximum available speeds, irrespective of the size of the display screen. Such an approach wastes bandwidth and often requires video players to scale the received video up or down to correspond to their own screen sizes. For a given video content and encoding compression standard (such as MPEG-4), the data rate required for broadcast quality transmission to a device with a QVGA display is substantially lower than the data rate required for a display with D1 NTSC or D1 PAL resolution. One feature of the present invention is that it can dynamically request and/or adjust the bandwidth of the streamed video content to best match the currently selected video display.

In a similar fashion, the present invention can dynamically adjust the bandwidth of the streamed audio to best match the currently selected audio output device. For example, the present invention includes an internal mono speaker. The bandwidth requirement for a mono speaker is much less than the bandwidth requirement for using external speakers connected to the system. If the present invention detects the presence of external speakers or a stereo headset, then present invention can request and/or adjust the bandwidth of the streamed audio to best match the currently selected audio device.

### SUMMARY OF THE INVENTION

This disclosure discloses a dual mode set-top box that displays streamed video and/or plays streamed audio where both data streams are received from a media delivery network. The set-top box comprises a processor that executes an operating system, communications functions, media streaming functions, and media decoding functions. The set-top box includes both a wired and a wireless connection to the media delivery network. The set-top box also includes an internal video display and one or more external video outputs that display streamed video received from the media delivery network. Further, the set-top box includes an internal audio device and one or more external audio outputs that play streamed audio received from the media delivery network.

Additionally, the set-top box further includes a remote control receiver that provides user control. And, the set-top box comprises a telephone device to make and receive VOIP telephone calls through the media delivery network.

### DESCRIPTION OF THE DRAWINGS

To further aid in understanding the invention, the attached drawings help illustrate specific features one embodiment of the invention and the following is a brief description of the attached drawings:

FIG. 1 illustrates one embodiment of a dual mode set-top box with VOIP telephony capability.

FIG. 2 is a perspective view of one embodiment of the present invention of FIG. 1.

FIG. 3 is a detailed illustration of the front panel of one embodiment of the present invention.

FIG. 4 is an illustration of the connectivity of the back panel of one embodiment of the present invention.

FIG. 5 is a general illustration of the connectivity of one embodiment of the present invention.

FIG. 6 is a more detailed illustration of the connectivity of one embodiment of the present invention.

FIG. 7 is a schematic illustration for one embodiment of the present invention.

FIG. 8 is an embodiment of an external audio device detection circuit for the present invention.

FIG. 9 is an embodiment of an external video device detection circuit for the present invention.

FIG. 10 is an example embodiment of the mobile display mode for the present invention.

FIG. 11 is an example embodiment of the fixed display mode for the present invention.

FIG. 12 is a flowchart of one embodiment of the audio services startup in the present invention.

FIG. 13 is a flowchart of one embodiment of the video services startup in the present invention.

FIG. 14 is a flowchart of one embodiment of adjacent channel buffering when a user is channel surfing in the present invention.

FIG. 15 illustrates one embodiment of the operation of a media manager server in the present invention.

FIG. 16 is embodiment of a headphone detector in the present invention.

### DETAILED DESCRIPTION OF THE INVENTION

The present invention is a method and apparatus for a portable dual mode set-top box that optimizes the streaming of video and/or audio over data networks and includes VOIP telephony capability. This disclosure describes numerous specific details that include specific encodings, structures, circuits, and logic functions in order to provide a thorough understanding of the present invention. One skilled in the art will appreciate that one may practice the present invention without these specific details. Additionally, this disclosure does not describe some well-known structures in detail in order not to obscure the present invention.

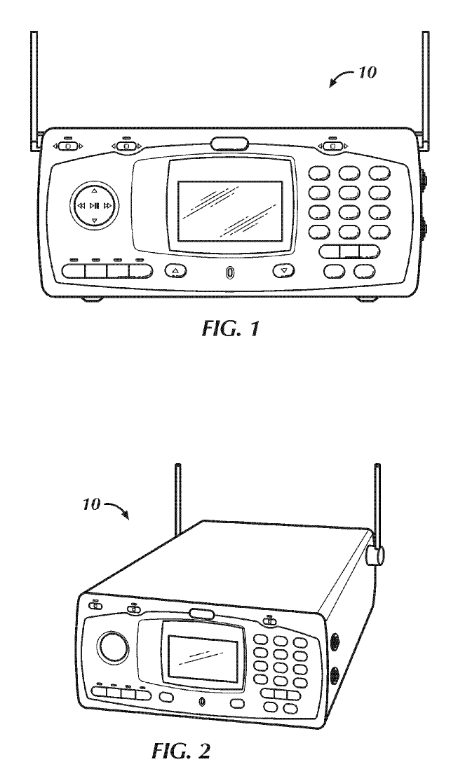

FIG. 1 illustrates one embodiment of the present invention that is a dual mode set-top box 10. The dual mode designation arises as the set-top box can attach to a media delivery network such as cable or the Internet through a wired (fixed) or wireless (mobile) connection. FIG. 2 is a perspective view of the set-top box 10.

The set-top box has a TV interface (connecting by RCA jacks or an S video interface) and remote control capability. It can be used in a method similar to traditional set-top boxes. But, unlike fixed (wired) set-top boxes, the user can take his subscription with him around the house or outside where ever a Wi-Fi network or cellular data network signal is available.

The set-top box reports its display size to the server when requesting a video data stream. The media server adjusts the data transmission rate to correspond to the size of the display that has been reported. The size may be QVGA (for stand-alone operation) or D1 NTSC or D1 PAL when connected to a TV.

The set-top box determines when its TV output is connected to a TV through one of two methods. The set-top box may determine when the TV output is connected to a TV by an electrical detection method such as through an A/D converter or line current monitor. Alternatively, the set-top box may determine that the user wishes to use the TV output because the user has pressed an input key on the unit.

It is possible that the media server may use different encoders based on the screen size and automatically switch between them. For example, it may use the MPEG-4 Simple Profile (SP) codec for QVGA but the higher-complexity H.264 codec if a television set or external monitor is connected.

Screen size may not be the only factor that affects the content encoding rate. Other factors that affect the content encoding rate may include available connection speed, the type of content, and the loading of the media sever.

When connected to a TV, the set-top box may blank out its internal LCD screen, or it may use both displays. If both the TV and the internal LCD screen are used, the set-top box down-scales the video data (transmitted in D1 NTSC resolution, for example) to fit on the internal QVGA-resolution LCD screen.

If a video streaming session is already underway when the TV output is connected to the TV, the set-top box sends a message to the video server requesting it to support a different screen size (and therefore to send the data at a different rate). The media server will then change its video encoding parameters to correspond to the new screen size. Additionally, the set-top box can also switch codecs as well. The present invention uses the most efficient bandwidth for delivery of dynamically changing speed/resolution/codec.

In order to reduce the inherent delays associated with browsing through channels, the set-top box can stream adjacent audio or video channels at a reduced rate, so that if the user selects one channel up/down (or preferred channel up/down), the content of these channels will be in a buffer memory and can be displayed right away. This technique to facilitate rapid user response is known as adjacent channel buffering. Immediately after selecting one channel up/down, the video content may be displayed at a smaller screen size, but will expand to normal resolution if the user keeps that choice for a few seconds.

To optimize audio streaming, the set-top box first determines if it is using its on-board mono speaker. When using the mono speaker, there is no need to encode audio in stereo or to encode audio in the high bit rates required for high fidelity reproduction. Connection to an external Audio/Visual system (an Audio/Visual Receiver or external speakers) or stereo headphones can be determined mechanically through a switch that is activated by the audio jack, or electrically through current or voltage monitoring on the audio output jack. If the set-top box detects an external audio connection, it requests a higher quality bit stream. It is possible that the media server may select a different codec to provide higher quality or multi-channel support (5.1 surround sound, for example) if external speakers are used. For example, the media sever may transmit audio using MP3 encoding at 32 Kbps (Kilobits per second) for playing on the set-top box's on-board mono speaker, or it may encode audio using Dolby AAC encoding at 128 Kbps if external speakers are used.

The set-top box has a built-in VOIP speakerphone that may be linked to the media content. For example, the user may order goods and services that relate to the program that he is watching by pressing just one or two buttons. By adding an optional CompactFlash camera, the set-top box also supports video conferencing.

The set-top box features dedicated control buttons for each CompactFlash socket that it supports and for the Wi-Fi radio. This enables the user to readily manipulate these devices and view status LEDs associated with their operation.

The set-top box operates in two modes: a fixed display (wired to TV) mode and a mobile display (no external display) mode.

FIG. 11 is an example embodiment of the fixed display mode for the present invention. Operation in the fixed display mode differs in a sense that in addition to responding to the front panel user interface keys 1100, the set-top box 10 will also respond to commands sent from a infrared remote control unit 1102. The set-top box 10 enters into the fixed display mode when it detects the presence of a TV 1106 plugged into the back panel RCA jacks 1104. In that case, set-top box 10 will request audio and video from a high-bandwidth media server in order to receive a compressed video transmission of a resolution that is high enough for full-size TV at D1 NTSC or D1 PAL resolution. Other resolutions may also be supported.

In the fixed display mode, the set-top box 10 also disables power savings and runs at its maximum available processor speed to maximize the audio and video decoding performance.

If a wired Ethernet connection 1110 is available, it may be used as the connection to the Internet 20 in lieu of a wireless Wi-Fi connection 1108.

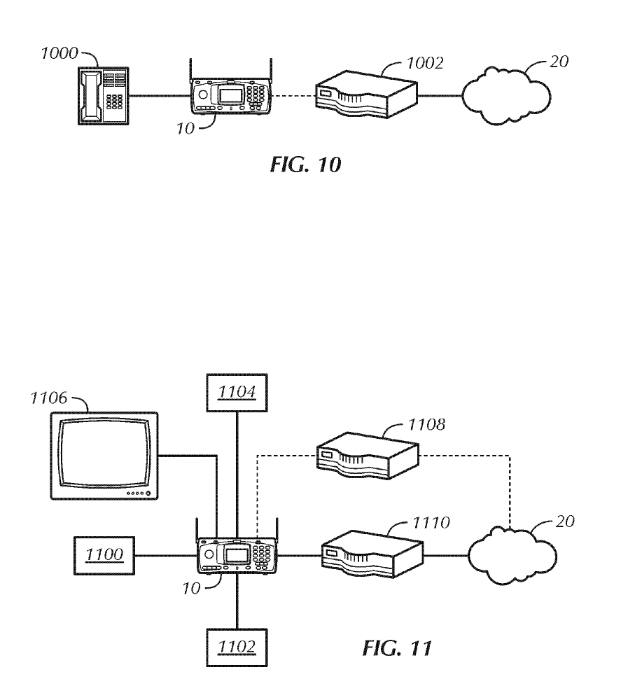

FIG. 10 is an example embodiment of the mobile display mode for the present invention. While operating in the mobile display mode, the set-top box 10 functions as a portable radio receiver and TV set-top box with an integrated speakerphone. In this mode, the set-top box 10 is usually powered by its internal battery and employs power-saving techniques. It connects to the Internet 20 through wireless data networks 1002 with either its built-in Wi-Fi radio or with CompactFlash-based cellular data modems to cellular networks. The local speaker and LCD display provide the means for accessing radio and TV programming, while the built-in speakerphone and keypad and the optional external headset 1000 provide telephony services. Short Message System (SMS) messaging is also available though the telephone keypad. As embodied in this implementation of the present invention, the internal LCD screen has a resolution of 320×240 pixels. A bandwidth of 200 Kbps to 300 Kbps is usually sufficient to display good quality video on the internal LCD screen.

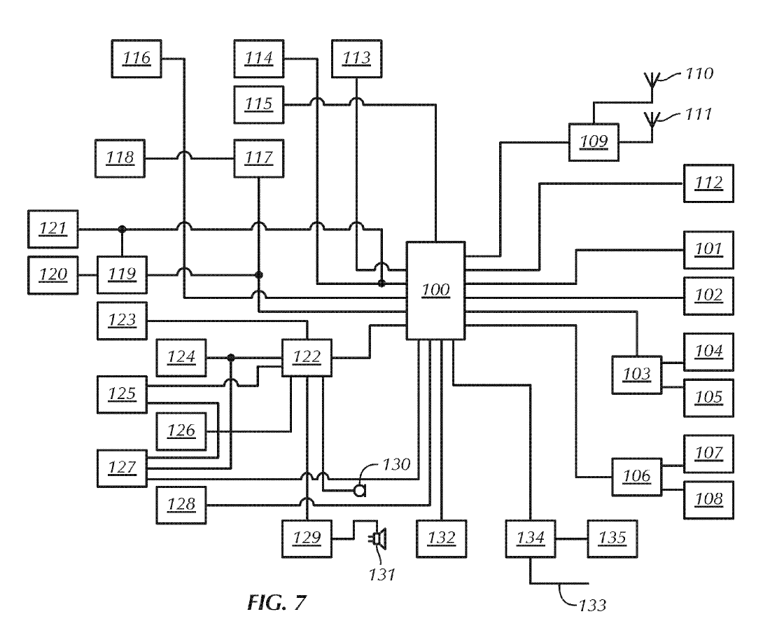

The example set-top box of FIG. 7 is controlled by an application processor 100, such as the Intel PXA255, which is optimized for low power utilization and multimedia applications. A real-time operating system, such as embedded Linux or Windows CE, runs on the application processor and provides networking, communications, timing, storage, and input/output (I/O) functions. In this embodiment of the invention, 64 MB of SDRAM 101 and 32 MB of Flash memory 102 comprise the embodied memory subsystem. The example PXA255 application processor features CompactFlash logic, but requires buffering and 5 volt level shifting 1 03 in order to support the two CompactFlash sockets 104 and 105. A variety of CompactFlash modules are available from third parties and enable the set-top box to extend its capabilities. Readily available CompactFlash modules include a camera, a GSM/GPRS data modem, an EV-DO data modem, and a micro-Hard drive. A USB Host controller 106, such as the TransDimension TD242LP, adds a USB-compatible host port 107 and one USB On-The-Go (OTG) port 108. The USB ports are used for communication with such devices as personal computers, Ethernet adapters, HomePlug networking adapters (HPNA), and analog telephone adapters (ATA). An Ethernet controller 112, such as the Cirrus Logic CS8900A, provides a 10 BaseT Ethernet port. A Wi-Fi module 109, such as the Philips BGW200, provides a low-power 802.11b radio. Two external antennae 110 and 111 provide diversity for maximum Wi-Fi radio performance at 2.4 GHz. An IrDA transceiver 113, such as the Agilent HSDL2300, provides fast, full-duplex infra-red communication with external peripherals such as mobile telephones and personal digital assistants (PDAs). An infra-red receiver 114, such as the Vishay TSSOP32236, allows the set-top box to be controlled by consumer remote control devices. User input is provided through 23 keys, five 3-way navigation switches, and one 5-way navigation switch 115. Six LED drivers 116 provide visual status indications to the user. A display interface chip 117, such as the Casio CM7200F1, provides an interface to an LCD screen 118, such as the Casio COM35H3125 QVGA TFT LCD module. A television encoder 119, such as the Chrontel CH7013, provides a composite video interface compatible with either NTSC or PAL standards. An RCA jack 120 provides a TV output signal. The Chrontel CH701 3 features a TV detection circuit. An additional TV detection circuit 121 is also provided in this example embodiment. An AC'97-compatible audio codec 122, such as the Sigmatel STAC9751, provides analog-to-digital and digital-to-analog conversion, as well as audio filtering, mixing, and volume control. The Sigmatel STAC9751 audio codec features a pre-amp circuit suitable for interface to microphones and a headphone amplifier. Line audio out is provided through two RCA jacks 124 and 125 and a 3.5 mm stereo headphone jack 126 provides the connection to an external headphone. An external audio detector circuit 127 is provided to detect when one of the two line out jacks or the headphone jack are connected externally. When external audio is in use, the set-top box mutes the local audio on the local mono speaker 131. A local microphone 130 and 1 Watt speaker 131 are used as a part of the speakerphone function. A 2.5 mm standard telephone headset jack 123 provides an interface to an external headset for greater privacy. A telephone headset detector circuit 128 is used to detect the presence of a headset, and when a headset is detected, the local microphone and speaker are turned off. An optional docking port 132 provides a convenient access to all of the system's inputs and outputs as well as AC powering. The set-top box is powered from an external power adapter that provides 9 volts at 2 amperes into a power jack 133. A DC-DC voltage regulation system 134 provides the required internal voltages of 5V, 3.3V, and 1.5V, as well as providing battery charging and management functions. A high-capacity Lithium-Ion (LI) battery 135 provides the necessary power for standalone operation. In this embodiment of the present invention, a 7.2V DC LI battery capable of delivering 2200 mAh was chosen.

FIG. 3 is a detailed illustration of the front panel of one embodiment of the present invention. The six Mode buttons shown in FIG. 3 are:

| | |
|---|---|
| (1) | TV (32) |
| (2) | RADIO (33) |
| (3) | HOME (34) |
| (4) | SETUP (35) |
| (5) | VIDEO PHONE (36) |
| (6) | MESSAGING (37) |

When pressed, the TV button 32 places the set-top box in a TV streaming mode, allowing the user to browse and view available TV and pay-per-view programs. This button also puts the set-top box in a fixed display mode.

When pressed, the RADIO button 33 places the set-top box in a radio streaming mode, allowing the user to browse and view available radio, music, and audio services. While in the radio mode, it is possible for the set-top box to receive images that may be transmitted by the content providers. Browsing functions and transmitted images appear on the internal LCD screen 118 and/or on an external TV if one is connected to the set-top box.

When pressed, the HOME button 34 stops any audio or video streaming and provides access to a phonebook, to games, and to other applications programs that are stored on a CompactFlash module. Browsing functions for the phonebook, games, and CompactFlash-based applications appear on the internal LCD screen 118 and/or on an external TV if one is connected to the set-top box.

When pressed, the SETUP button 35 provides the user the ability to view and change his account settings, ring tones, radio and TV channel preferences, preferred language, and other functions. This setup information appears on the internal LCD screen 118 and/or on an external TV if one is connected to the set-top box.

When pressed, the VIDEO PHONE button 36 activates video conferencing functions. A CompactFlash-based plug-in video camera is required to capture and transmit the picture of the user. The internal VOIP phone handles voice communication for the conference, and the video images are displayed on the internal LCD screen 118 and/or on an external TV if one is connected to the set-top box.

When pressed, the MESSAGING button 37 allows the user to access his saved voice messages, text (short messaging system or SMS) messages, and to compose and send new messages. The user interface for messages is displayed on the internal LCD screen 118 and/or on an external TV if one is connected to the set-top box.

It should be noted that the VOIP telephone function is available at all times and supersedes any of the six main operating modes. For example, if the user wishes to place a telephone call while viewing a TV program, he can press the telephone off-hook button 38 and dial the telephone number using the numeric keypad 41. The TV program will be turned off while the telephone call is in progress.

The following telephony buttons are provided:
A green handset 38 symbolizes going OFF-HOOK to answer an incoming call or to place an outgoing call.
A red handset 40 symbolizes going ON-HOOK to terminate a call or to abort an attempted outgoing call.
The telephone keypad 41 consists of the keys 0, 1, 2, 3, 4, 5, 6, 7, 8, 9, 0, *, #. Alphanumeric characters are superimposed on these keys to support alphanumeric numbers or to compose SMS messages.
As digits are dialed, they are displayed on the internal LCD screen 118 and/or the external TV display if one is connected.
The CLEAR button 39 allows the user to delete the last digit entered, in case of misdialing.

A 3-way navigation switch labeled “Wi-Fi” 42 allows the user to view available Wi-Fi networks (displayed on the internal LCD screen and/or the external TV display if one is connected) and to select a Wi-Fi network. It also allows the user to set encryption keys using the keypad 41 for Wi-Fi for greater security and privacy. A bi-color LED 43 above the switch displays the status of the Wi-Fi connection. The LED 43 is green when a good Wi-Fi connection is available, flashing red when the Wi-Fi connection is intermittent and steady red when the Wi-Fi connection is not available or is unusable.

Two 3-way navigation switches labeled “CF1” 30 and “CF2” 31 provide user control and configuration of the modeules that may be plugged into the CompactFlash sockets 104 and 105. The switches operate in a similar manner as the Wi-Fi switch 42, i.e. the user can navigate and select all available configuration options (displayed on the internal LCD screen and/or the external TV display if one is connected). Bi-color LEDs (44 for “CF1” and 45 for “CF2”) indicate normal (green), marginal (flashing red), or abnormal (steady red) operation of the plugged-in CompactFlash module.

A 5-way navigation switch 46 allows the user to control the channel selection of the TV or radio and to navigate while in the Home or Set up Modes. This navigation switch also provides audio and video controls such as play, pause, fast forward, and rewind.

A 3-way navigation switch 47 to the side of the set-top box provides volume and tone control for internal audio. A second 3-way navigation switch 48 to the side of the unit provides video brightness, color, and tint control for internal video.

Two soft keys 49 and 50 allow the user to select “soft” options that are displayed on the LCD. The options and the functions performed by these soft keys are application-specific.

The front panel display in FIG. 3 also contains an IrDA transceiver for fast, full duplex communication with external peripherals such as mobile telephones and PDAs. In addition, the front panel also contains the local microphone 130 for use with the VOIP speakerphone functions.

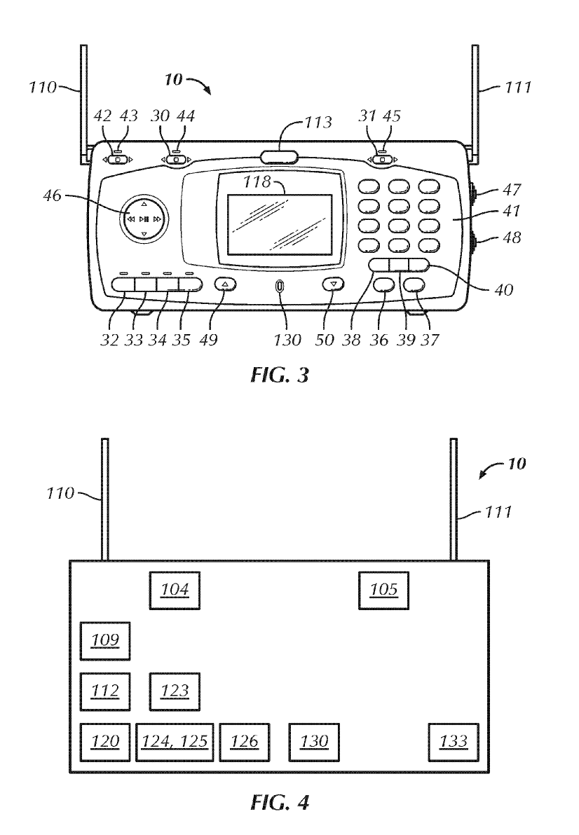

FIG. 4 is an illustration of the connectivity of the back panel of one embodiment of the present invention. The back panel contains two CompactFlash slots 104 and 105, a microphone 130, a Wi-Fi module slot 109, and an Ethernet controller jack 112. A standard telephone headset can be plugged into the headset jack 123. An external TV display can be plugged into the RCA jack 123, and external audio can be connected through the audio line out RCA jacks 124 and 125. External headphones can be plugged in through the 3.5 mm stereo headphone jack 126. Finally, power is provided to the set-top box through the power jack 133.

FIG. 13 is a flowchart of one embodiment of the video services startup in the present invention. When the set-top box is powered up 1300, it determines if there is a connection to an external TV or other screen 1302. If it detects an external video connection, it will enter the TV mode and request a high resolution, high bandwidth big screen compressed video stream of the last channel that was previously accessed 1306. If the set-top box does not detect an external video connection, then it determines the mode selected by the user 1303. If the user presses the front panel TV mode button, it will request a lower resolution, lower bandwidth small screen compressed video stream 1304. The high bandwidth video stream and the low bandwidth video stream may or may not use the same video codec for video compression. The set-top box then continues to receive either the high or low bandwidth format of video stream until it detects a change in connection 1308. If the user does not press the front panel TV mode button, the set-top box will enter a power-saving standby mode where only the VOIP telephone functions are available 1305. The user must press one of the six front panel mode buttons in order to activate the various additional functions.

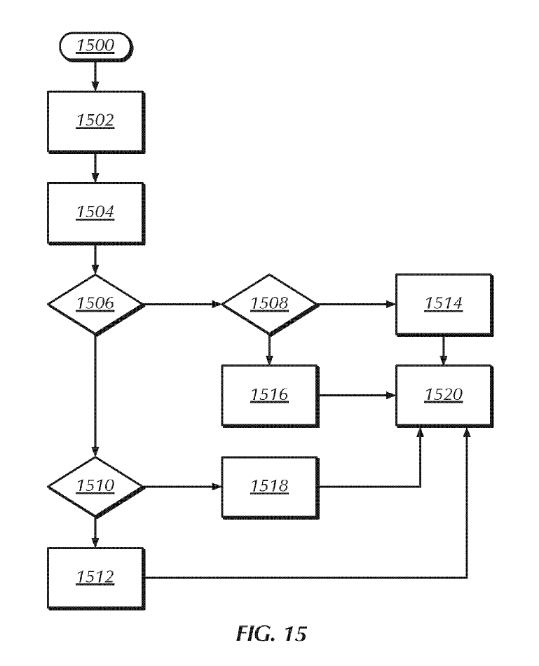

FIG. 14 is a flowchart of one embodiment of adjacent channel buffering when a user is channel surfing in the present invention. When the set-top box is powered up 1400, it requests the active channel stream at 100% quality for the currently selected display device(s) 1402. When a user changes the channel 1403, to speed up reception of the new video stream the set-top box will request multiple streams from channels above and below the current selection at 20% quality 1404. When the user remains on one channel for a certain amount of time 1405, the set-top box requests the active channel stream at 100% quality again, seamlessly ending the low quality stream and starting the high quality stream, so the user does not notice the transition 1406.

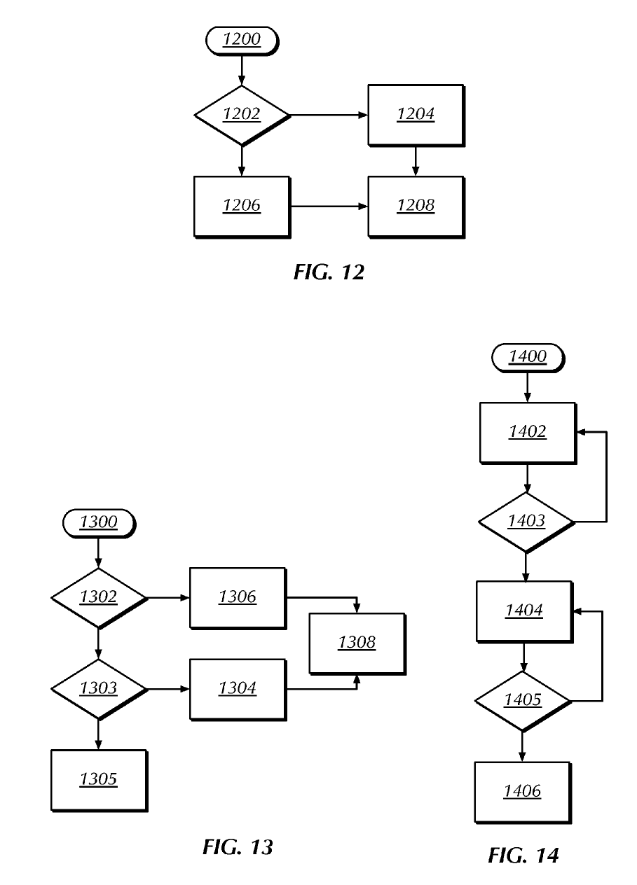

FIG. 12 is a flowchart of one embodiment of the audio services startup in the present invention. When the set-top box is powered up 1200, it determines if there is a connection to an external speaker 1202. If it detects an external audio connection, it will request a high bandwidth compressed stereo audio stream 1204. If there is no connection to an external speaker 1202, the set-top box will request a low bandwidth mono compressed audio stream 1206. The high bandwidth stereo audio stream and the low bandwidth mono audio stream may or may not use the same audio codec for compressing the audio stream. The set-top box then continues to receive the same format of audio stream until it detects a change in connection 1208.

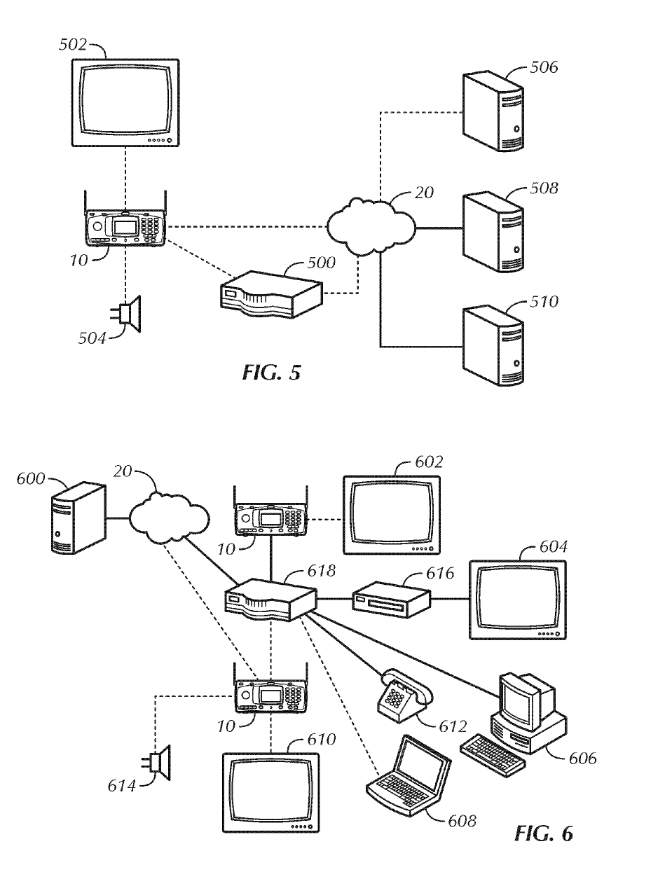

FIG. 5 is a general illustration of the connectivity of one embodiment of the present invention. The set-top box 10 is a portable device; therefore it may be used in the home, perhaps behind a firewall 500, or outside the home, also perhaps behind a firewall. A wired or wireless connection to the Internet 20 is all that is needed. The set-top box 10 will use a list of media servers such as a low bandwidth server 510 or high bandwidth server 508 to receive media content from. The media content is either maintained on the set-top box's flash memory or on a media manager server 506 in a remote location on the Internet. The set-top box 10 has the ability to scan its physical connections and determine if there are external speakers 504 and/or an external display 502 attached, and request the appropriate audio and video resolution and quality to download. The set-top box 10 may utilize a different media server for low or high bandwidth streams (as shown in FIG. 5), or it may select different quality streams from the same media server.

FIG. 15 illustrates one embodiment of the operation of a media manager server in the present invention. The set-top box works in conjunction with dedicated media streaming servers that provide access authentication and streaming media content. These servers are designed to provide high Quality of Service (QoS) for broadcast-grade quality service to users.

The media manager server responds to requests for multimedia content from set-top boxes. When the media manager server is powered up 1500, the media manager server 506 (FIG. 5) waits for requests from set-top boxes 1502. When the media manager server receives a set-top box request for media content 1504, it evaluates the connection parameters that were sent with the request, and directs the set-top box to the appropriate media stream. The connection parameters of the request indicate to the media manager server 506 if there is an external speaker system connected 1506 to the set-top box. The connection parameters of the request also indicate to the media manager server 506 if there is an external screen connected 1508 and 1510 to the set-top box. If the connection parameters indicate that no external video screen 1510 and no external speakers 1506 are connected to the set-top box, then the media manager server 506 routes the set-top box 10 to a low video resolution, low bandwidth audio media stream server 1512. If the connection parameters indicate that no external video screen 1508 is present but that there are external speakers 1506 connected to the set-top box, then the media manager server 506 routes the set-top box to a low video resolution, high bandwidth audio media stream server 1516. If the connection parameters indicate that there is an external video screen 1508 and there are external speakers 1506 connected to the set-top box, then the media manager server 506 routes the set-top box to a high bandwidth audio and video media stream server 1514. And finally, if the connection parameters indicate that an external video screen 1510 is present but no external speakers 1506 are connected to the set-top box, then the media manager server 506 routes the set-top box to a high video resolution, low bandwidth audio media stream server 1518. The media manager server continues to service the set-top box from the selected grade of media server until the connection parameters change 1520.

FIG. 6 is a more detailed illustration of the connectivity of one embodiment of the present invention, and also illustrates typical usage in a home environment. The set-top box 10 has jacks to plug in a TV and external speakers. As such, it may be used standalone (utilizing internal video and audio) or as a set-top box for a TV or stereo. An external screen or speakers are not required. For portable use, the set-top box 10 needs a Wireless Access Point or some other connection to the Internet 20 to stream the media content from a media server 600. It is also possible to access content when mobile, so that a user may take the channels to which they have subscribed anywhere they have Internet 20 access. Wired Ethernet can be used to connect from the home router 618 to the set-top box 10 with an external TV display 602, and in this configuration it is a superset replacement of the traditional fixed set-top box 616 with external TV display 604. With user applications resident on a CompactFlash module, this configuration is also a superset replacement of the traditional desktop computer 606. The traditional desktop computer 606, with appropriate software, can also be used to receive streaming multimedia content from the Internet 20, and the set-top box 10 is also a superset replacement for the desktop computer 606 in this mode. Alternatively, Wi-Fi can be used to connect the set-top box 10 to the home router 618 or directly to the Internet 20. When this configuration is combined with an optional external TV display 610 and/or optional external speakers 614, it is a direct superset replacement of the traditional fixed set-top box 616 with external TV display 604. With user applications resident on a CompactFlash module, this configuration is also a superset replacement of the Wi-Fi enabled laptop computer 608. Either wired to the home router 618 with Ethernet, or wirelessly connected with Wi-Fi, the set-top box 10 also provides a replacement of an Internet-enabled phone 612 through its inclusion of VOIP telephony features. As either a desktop computer 606 or a laptop computer 608 with the appropriate software can also be used as an Internet-enabled phone, the set-top box 10 also provides a replacement of these computer functions.

One use of this invention relates to international program content. It is possible to configure the set-top box working with the right audio/video/VOIP servers to operate as a media device for given countries or regions of the world. As an example, the set-top box could be configured as a media gateway into New Delhi, India. In that case, all the major radio and TV broadcasts that are available in New Delhi may be accessible from this device (as if it were getting them directly off-the-air in New Delhi). Furthermore, a local Delhi telephone number may be assigned to it, so the user may receive phone calls into the unit by dialing a local number (which is forwarded over IP networks to the VOIP telephony gateway that is serving the unit).

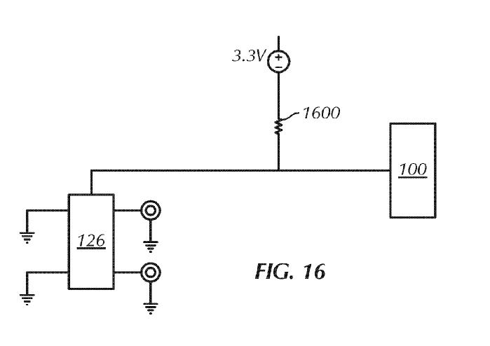

FIG. 16 is an embodiment of a headphone detector in the present invention. A headphone detect signal is monitored by the application processor 100. This signal changes from logic high to logic low indicating the connection of the external audio device. One implementation of this method involves using a 3.5 mm stereo jack socket 126 with an internal switch, such as the CUI SJ3566AN. The CUI SJ3566AN headphone jack socket 126 features a normally closed switch between pins 4 and 5. Pin 4 is left open, so that the headphone detect signal is pulled high by the 4.7 K ohms resistor 1600. When an external headphone jack is plugged in, the connection between pins 4 and 5 is open and pin 5 is connected to pin 6, which is grounded. This will, in turn, pull the headphone detect signal low. The application processor 100 monitoring the headphone detect signal will recognize the change from logic high to logic low as indicating the connection of an external audio device.

FIG. 8 is an embodiment of a different method to detect external audio in the present invention. In this method, which the load impedance of the external audio device is used to indicate the connection. This method is suitable for a connection system such as an RCA plug and socket. This implementation monitors the Line Out Right RCA socket 125. The Line Out Right signal is fed into this RCA socket through a feed resistor 136 which is resistive enough to be AC loaded by the connection of the external audio device. The level of the output signal is fed to a high-impedance signal buffer and filter 137. An Analog-to-Digital Converter (ADC) 138, such as the Maxim MX7705, is used to measure the amplitude of the signal and report it to the application processor 100. The application processor 100 will determine the RMS level of the monitored signal and compare it to an internal reference level. If the monitored signal is higher than the internal reference level, the Line Out Right socket is open and no device is plugged in. If the monitored signal is lower than the reference level, then Line Out Right is loaded by an external device, such as the input stage of an audio amplifier. The ADC communicates with the application processor 100 using the standard Serial Peripheral Interface (SPI) protocol.

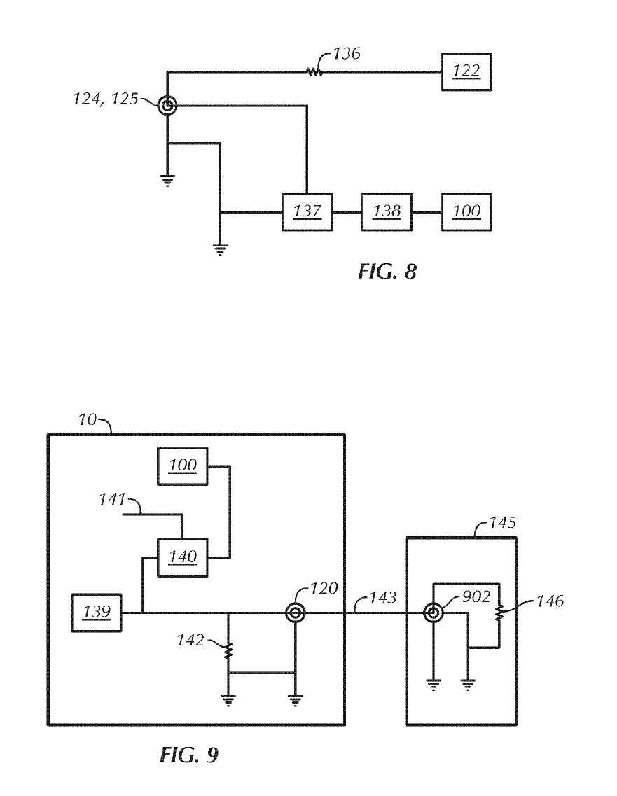

FIG. 9 is an embodiment of an external video device detection circuit for the present invention. This method is predicated on the fact that the video interface usually presents a low DC load. A fixed current source 139 is used to source current into the 75 ohms source impedance 142. The voltage at the resistor terminal is input to a voltage comparator 140 and compared against a fixed reference voltage 141. The TV Out signal is provided through an RCA jack 120. An external cable 143 is used to connect the video output of the set-top box to the input RCA jack 144 of an external television set 145. When an external video display device is plugged in to the video output of the set-top box, the load impedance 146 appears in parallel with the source resistance 142 and the DC voltage drops. The voltage comparator 140 provides an indication to the application processor 100 through one of the processors' I/O ports that an external display device has been detected.

In summary, this disclosure discloses a dual mode set-top box that displays streamed video and/or plays streamed audio where both data streams are received from a media delivery network. The set-top box comprises a processor that executes an operating system, communications functions, media streaming functions, and media decoding functions. The set-top box includes both a wired and a wireless connection to the media delivery network. The set-top box also includes an internal video display and one or more external video outputs that display streamed video received from the media delivery network. Further, the set-top box includes an internal audio device and one or more external audio outputs that play streamed audio received from the media delivery network. Additionally, the set-top box further includes a remote control receiver that provides user control. And, the set-top box comprises a telephone device to make and receive VOIP telephone calls through the media delivery network.

Other embodiments of the invention will be apparent to those skilled in the art after considering this specification or practicing the disclosed invention. The specification and examples above are exemplary only, with the true scope of the invention being indicated by the following claims.

1. A dual mode set-top box that displays streamed video and/or plays streamed audio where both data streams are received from a media delivery network, comprising:
a processor that executes an operating system, communication functions, media streaming functions, and media decoding functions;
a wired connection to the media delivery network wherein said wired connection couples to said processor;
a wireless connection to the media delivery network wherein said wireless connection couples to said processor;
an internal video display and one or more external video outputs that display streamed video received from the media delivery network wherein said internal video display and said external video outputs couple to said processor; and
an internal audio device and one or more external audio outputs that play streamed audio received from the media delivery network wherein said internal audio device and said external audio outputs couple to said processor.

2. A system that uses a dual mode set-top box that displays streamed video and/or plays streamed audio where both data streams are received from a media delivery network, comprising:
a processor that executes an operating system, communication functions, media streaming functions, and media decoding functions;
a wired connection to the media delivery network wherein said wired connection couples to said processor;
a wireless connection to the media delivery network wherein said wireless connection couples to said processor;
an internal video display and one or more external video outputs that display streamed video received from the media delivery network wherein said internal video display and said external video outputs couple to said processor; and
an internal audio device and one or more external audio outputs that play streamed audio received from the media delivery network wherein said internal audio device and said external audio outputs couple to said processor.

3. A method to manufacture a dual mode set-top box that displays streamed video and/or plays streamed audio where both data streams are received from a media delivery network, comprising:
providing a processor that executes an operating system, communication functions, media streaming functions, and media decoding functions;
providing a wired connection to the media delivery network wherein said wired connection couples to said processor; providing a wireless connection to the media delivery network wherein said wireless connection couples to said processor;
providing an internal video display and one or more external video outputs that display streamed video received from the media delivery network wherein said internal video display and said external video outputs couple to said processor; and
providing an internal audio device and one or more external audio outputs that play streamed audio received from the media delivery network wherein said internal audio device and said external audio outputs couple to said processor.

4. A method to use a dual mode set-top box that displays streamed video and/or plays streamed audio where both data streams are received from a media delivery network, comprising:
executing an operating system, communication functions, media streaming functions, and media decoding functions using a processor;
providing a wired connection to the media delivery network wherein said wired connection couples to said processor;
providing a wireless connection to the media delivery network wherein said wireless connection couples to said processor;
providing an internal video display and one or more external video outputs that display streamed video received from the media delivery network wherein said internal video display and said external video outputs couple to said processor; and
providing an internal audio device and one or more external audio outputs that play streamed audio received from the media delivery network wherein said internal audio device and said external audio outputs couple to said processor.

5. A program storage device readable by a computer that tangibly embodies a program of instructions executable by the computer to perform a method to use a dual mode set-top box that displays streamed video and/or plays streamed audio where both data streams are received from a media delivery network, comprising:
executing an operating system, communication functions, media streaming functions, and media decoding functions using a processor;
providing a wired connection to the media delivery network wherein said wired connection couples to said processor;
providing a wireless connection to the media delivery network wherein said wireless connection couples to said processor;
providing an internal video display and one or more external video outputs that display streamed video received from the media delivery network wherein said internal video display and said external video outputs couple to said processor; and
providing an internal audio device and one or more external audio outputs that play streamed audio received from the media delivery network wherein said internal audio device and said external audio outputs couple to said processor.

6. A dependent claim according to claims 1, 2, 3, 4, or 5 that further comprises a remote control receiver that provides user control wherein said remote control receiver remotely couples to said processor through an infrared interface.

7. A dependent claim according to claims 1, 2, 3, 4, or 5 that further comprises a telephone device to make and receive VOIP telephone calls through the media delivery network wherein said telephone device couples to said processor.

8. A dual mode set-top box that displays streamed video and/or plays streamed audio where both data streams are received from a media delivery network, comprising:
a processor that executes an operating system, communication functions, media streaming functions, and media decoding functions;
a wired connection to the media delivery network wherein said wired connection couples to said processor;
a wireless connection to the media delivery network wherein said wireless connection couples to said processor;
an internal video display and one or more external video outputs that display streamed video received from the media delivery network wherein said internal video display and said external video outputs couple to said processor;
an internal audio device and one or more external audio outputs that play streamed audio received from the media delivery network wherein said internal audio device and said external audio outputs couple to said processor;
a remote control receiver that provides user control wherein said remote control receiver remotely couples to said processor through an infrared interface; and
a telephone device to make and receive VOIP telephone calls through the media delivery network wherein said telephone device couples to said processor.

9. A system that displays streamed video and/or plays streamed audio where both data streams are received from a media delivery network, comprising:
a processor that executes an operating system, communication functions, media streaming functions, and media decoding functions;
a wired connection to the media delivery network wherein said wired connection couples to said processor;
a wireless connection to the media delivery network wherein said wireless connection couples to said processor;
an internal video display and one or more external video outputs that display streamed video received from the media delivery network wherein said internal video display and said external video outputs couple to said processor;
an internal audio device and one or more external audio outputs that play streamed audio received from the media delivery network wherein said internal audio device and said external audio outputs couple to said processor;
a remote control receiver that provides user control wherein said remote control receiver remotely couples to said processor through an infrared interface; and
a telephone device to make and receive VOIP telephone calls through the media delivery network wherein said telephone device couples to said processor.

10. A method to manufacture a dual mode set-top box that displays streamed video and/or plays streamed audio where both data streams are received from a media delivery network, comprising:
providing a processor that executes an operating system, communication functions, media streaming functions, and media decoding functions;
providing a wired connection to the media delivery network wherein said wired connection couples to said processor;
providing a wireless connection to the media delivery network wherein said wireless connection couples to said processor;
providing an internal video display and one or more external video outputs that display streamed video received from the media delivery network wherein said internal video display and said external video outputs couple to said processor;
providing an internal audio device and one or more external audio outputs that play streamed audio received from the media delivery network wherein said internal audio device and said external audio outputs couple to said processor;
providing a remote control receiver that provides user control wherein said remote control receiver remotely couples to said processor through an infrared interface; and
providing a telephone device to make and receive VOIP telephone calls through the media delivery network wherein said telephone device couples to said processor.

11. A method to use a dual mode set-top box that displays streamed video and/or plays streamed audio where both data streams are received from a media delivery network, comprising:
executing an operating system, communication functions, media streaming functions, and media decoding functions using a processor;
providing a wired connection to the media delivery network wherein said wired connection couples to said processor;
providing a wireless connection to the media delivery network wherein said wireless connection couples to said processor;
providing an internal video display and one or more external video outputs that display streamed video received from the media delivery network wherein said internal video display and said external video outputs couple to said processor;
providing an internal audio device and one or more external audio outputs that play streamed audio received from the media delivery network wherein said internal audio device and said external audio outputs couple to said processor;
providing a remote control receiver that provides user control wherein said remote control receiver remotely couples to said processor through an infrared interface; and
providing a telephone device to make and receive VOIP telephone calls through the media delivery network wherein said telephone device couples to said processor.

12. A program storage device readable by a computer that tangibly embodies a program of instructions executable by the computer to perform a method to use a dual mode set-top box that displays streamed video and/or plays streamed audio where both data streams are received from a media delivery network, comprising:
executing an operating system, communication functions, media streaming functions, and media decoding functions using a processor;
providing a wired connection to the media delivery network wherein said wired connection couples to said processor;
providing a wireless connection to the media delivery network wherein said wireless connection couples to said processor;
providing an internal video display and one or more external video outputs that display streamed video received from the media delivery network wherein said internal video display and said external video outputs couple to said processor;
providing an internal audio device and one or more external audio outputs that play streamed audio received from the media delivery network wherein said internal audio device and said external audio outputs couple to said processor;
providing a remote control receiver that provides user control wherein said remote control receiver remotely couples to said processor through an infrared interface; and
providing a telephone device to make and receive VOIP telephone calls through the media delivery network wherein said telephone device couples to said processor.
